(19) United States
(12) Patent Application Publication
(10) Pub. No.: US 2005/0180486 A1
(43) Pub. Date: Aug. 18, 2005

(54) Laser module for circular saw

(76) Inventor: Hsin Chih Tung, Taipei (TW)

Correspondence Address: HSIN CHIH TUNG, P.O. BOX 26-757, TAIPEI, 106, TW

(21) Appl. No.: 10/779,115

(22) Filed: Feb. 13, 2004

(51) Int. Cl. H01S 3/08

(52) U.S. Cl. 372/101

(57) ABSTRACT

A laser module used in a circular saw to guide cutting of the saw blade of the circular saw is constructed to have a hollow housing, a focal lens mounted in the housing, a laser diode mounted in the housing behind the focal lens and beyond the focus of the focal lens, a circuit board electrically connected to the laser diode, a focal lens mounted in the housing in front of the laser diode beyond the focus of said focal lens, an annular endpiece threaded into the front side of the housing to hold the focal lens and rotatable relative to the housing to move the focal lens axially relative to the laser diode and to further adjust the pattern the light spot of the laser beam from the laser diode on the workpiece.

### BACKGROUND OF THE INVENTION

1. Field of the Invention

The present invention relates to a circular saw and, more specifically, to a laser module for use in a circular saw to guide cutting of the saw blade accurately along the cut line on the workpiece.

2. Description of the Related Art

A circular saw can rapidly and neatly cut a workpiece. For the advantage of high cutting efficiency, circular saws are intensively used for cutting wooden materials. Regular circular saws include two types, the portable type and the bench type. When a portable type circular saw is used, the operator needs to move the saw blade against a workpiece that is fixed in position. When a bench type circular saw is used, the circular saw is stationary, and the operator needs to move the workpiece against the saw blade of the circular saw. A circular saw may be equipped with a laser structure to guide cutting of the saw blade along the cut line on the workpiece.

A conventional laser structure comprises a case, a laser module, and a power control and supply unit. The laser module and the power control and supply unit are mounted in the case and affixed to the center of the circular saw. The laser module is electrically connected to the power control and supply unit, and controlled by the power control and supply unit to emit laser light. During cutting operation of the circular saw, the focal lens of the laser module focuses the laser beam of the laser diode onto the cut line on the workpiece for enabling the saw blade of the circular saw to follow.

The aforesaid laser structure is still not satisfactory in function. Because the laser diode is within the focus of the focal lens, the laser beam forms a small laser light spot on the workpiece before cutting, and forms a narrow line of laser light during cutting. Because the line of laser light has a narrow width, the user may be unable to see the line of laser light on the workpiece during cutting operation.

Therefore, it is desirable to provide a laser module for a circular saw that eliminates the aforesaid problem.

### SUMMARY OF THE INVENTION

The present invention has been accomplished under the circumstances in view. It is the main object of the present invention to provide a laser module for circular saw, which produces a laser beam that forms a big light spot on the workpiece before cutting with the circular saw and to form a strip of light on the workpiece during cutting with the circular saw, guiding the operator to move the saw blade accurately along the cut line on the workpiece.

To achieve this and other objects of the present invention, the laser module is used in a circular saw to guide cutting of the saw blade of the circular saw. The laser module comprises a hollow housing, a laser diode mounted in the housing, a circuit board electrically connected to the laser diode, and a focal lens mounted in the housing in front of the laser diode in such a position that the laser diode is beyond the focus of the focal lens.

### BRIEF DESCRIPTION OF THE DRAWINGS

The various objects and advantages of the present invention will be more readily understood from the following detailed description when read in conjunction with the appended drawing, in which:

FIG. 1 is an exploded view of a laser structure for a circular saw according to the present invention;

FIG. 2 is an elevational view of a laser module according to the present invention;

FIG. 3 is a cross-sectional view of the laser module according to the present invention;

FIG. 4 is a schematic drawing showing the operation of the laser module according to the present invention; and

FIG. 5 is a cross-sectional view of the laser module after removal of the lens holder and the lens.

### DETAILED DESCRIPTION OF THE PREFERRED EMBODIMENT

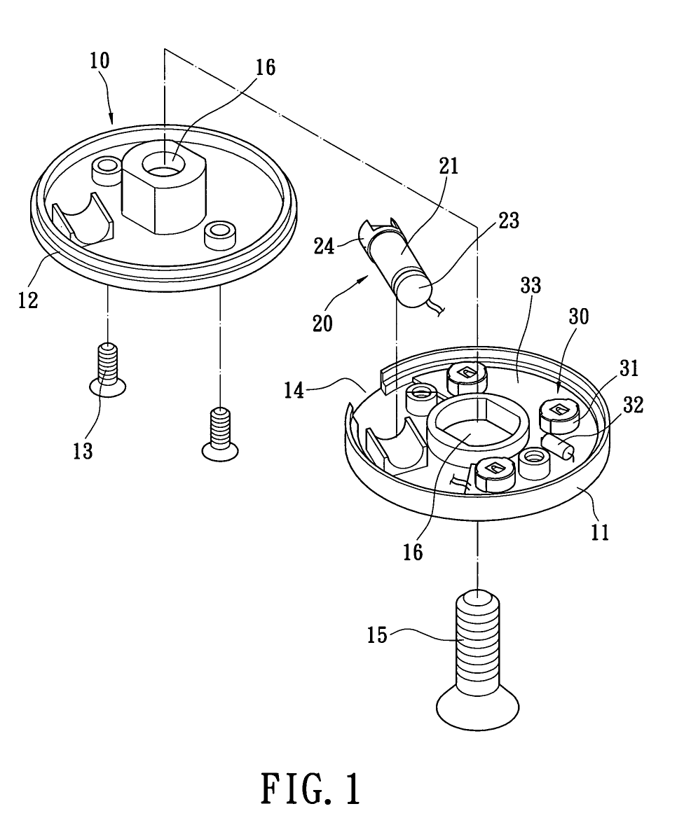

Referring to FIG. 1, a laser structure is provided in a circular saw (not shown), comprising a case 10, a laser module 20, and a power control and supply unit 30. The case 10 is formed of a top cover shell 11 and a bottom cover shell 12. The top cover shell 11 and the bottom cover shell 12 are fastened together with screws 15. The case 10 has a peripheral laser hole 14, and a center mounting hole 16 for mounting a screw 15 to affix the case 10 to the circular saw.

The laser module 20 and the power control and supply unit 30 are mounted inside the case 10. The power control and supply unit 30 comprises a battery set 31, a vibration switch 32, and a circuit board 33. The power control and supply unit 30 is electrically connected to the laser module 20, and adapted to drive the laser module 20 to emit laser light. The case 10 and the power control and supply unit 30 are of the known art and not within the scope of the claims of the present invention; therefore no further detailed description in this regard is necessary.

The laser module 20 comprises a housing 21, a laser diode 22, a circuit board 23, a lens holder 24, and a lens 25. The housing 21 is a tubular member having an outer thread 211 extended around the periphery at one end. The circuit board 23 can be a circular or rectangular circuit board mounted inside or at the rear side of the housing 21. Further, the circuit board 23 is electrically connected to the laser diode 22 and the power control and supply unit 30 and controlled by the power control and supply unit 30 to drive the laser diode 22 to emit laser light.

The housing 21 is internally mounted with an annular front endpiece 26, an internal lens 27, and a spring 28. The annular front endpiece 26 is threaded into the front end of the tubular housing 21. The internal lens 27 is a convex lens affixed to the annular front endpiece 26 in front of the laser diode 22. The spring 28 is mounted inside the housing 21 and pressed on the border area of the internal lens 27 against the annular front endpiece 26. The internal lens 27 and the laser diode 22 are axially aligned in line, and the laser diode 22 is beyond the focus of the internal lens 27. The annular front endpiece 26 can be rotated relative to the housing 21 to adjust the pitch between the internal lens 27 and the laser diode 22, and therefore the focal length of the laser diode 22 is adjusted.

The lens holder 24 is a hollow cylindrical cap fastened to the front end of the housing 21, holding the lens 25 on the inside. The lens 25 is adapted to refract light from the laser diode 22. The lens holder 24 has an inner thread 241. By means of threading the inner thread threaded onto the outer thread 211 of the housing 21, the lens holder 24 is fastened to the housing 21.

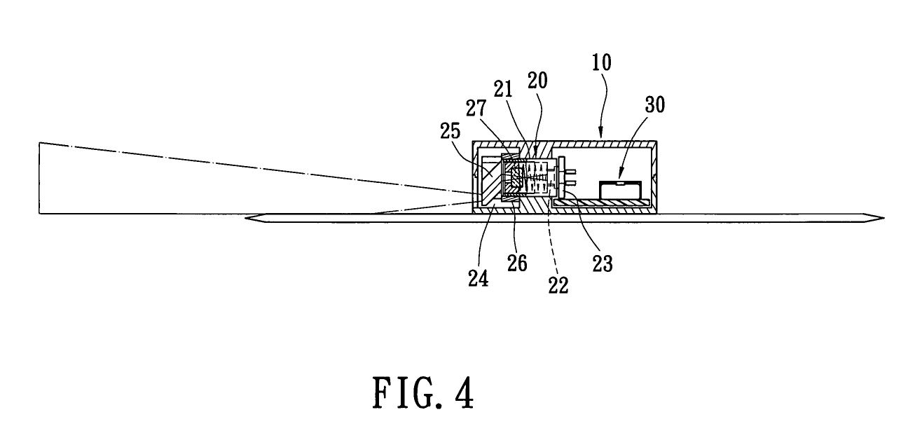

During operation of the laser module 20, the internal lens 27 focuses the light of the laser diode 22 onto the lens 25, for enabling the laser diode to be refracted by the lens 25 onto the target. Because the laser diode 22 is disposed beyond the focus of the internal lens 27, laser light passing from the laser diode 22 through the internal lens 27 is slightly dispersed, thereby producing a laser beam (see FIG. 4). When projected onto the workpiece, the laser beam forms a big point of light on the workpiece. When cutting the workpiece with the saw blade, the laser beam forms a strip of light on the workpiece, so that the operator can clearly see the indication of the laser light and accurately cut the workpiece with the saw disc of the circular saw subject to the indication of the laser light.

As indicated above, the laser diode 22 is set beyond the focus of the internal lens 27. The operator can adjust the pitch between the internal lens 27 and the laser diode 22 to further adjust the size of the laser beam subject to different needs, for example, for illumination.

The laser beam produced by the laser module 20 can be projected along the surface of the saw blade of the circular saw (see FIG. 4) onto the workpiece, helping the operator to aim the cutting edge of the saw blade of the circular saw at the cut line made on the workpiece.

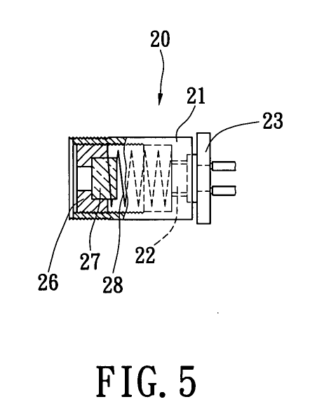

If refraction of laser light is not desired, the lens holder 24 and the lens 25 can be removed from the laser module 20 (see FIG. 5).

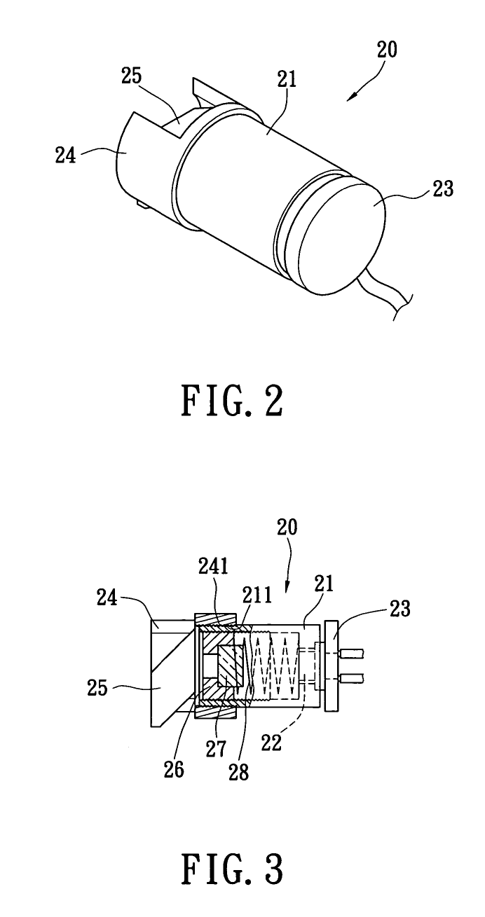

A prototype of laser module for circular saw has been constructed with the features of the annexed drawings of FIGS. 1-5. The laser module for circular saw functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

1. A laser module used in a circular saw to guide cutting of a saw blade of the circular saw, the laser module comprising:
a hollow housing;
a laser diode mounted in said housing;
a circuit board electrically connected to said laser diode; and
a focal lens mounted in said housing in front of said laser diode in such a position that said laser diode is beyond a focus of said focal lens.

2. The laser module as claimed in claim 1, further comprising a lens holder fastened to said housing, and a lens mounted inside said lens holder in line with said focal lens and said laser diode and spaced from said focal lens at one side opposite said laser diode.

3. The laser module as claimed in claim 2, wherein said lens holder is fastened to said housing by a screw joint.

4. The laser module as claimed in claim 1, further comprising an annular endpiece fastened to said housing by a screw joint and set in line with said laser diode to hold said focal lens in front of said laser diode and rotatable relative to said housing to adjust the pitch between said focal lens and said laser diode, and a spring member mounted inside said housing to hold down said focal lens on said annular endpiece.

5. The laser module as claimed in claim 1, wherein said circuit board is fastened to a rear side of said housing remote from said focal lens.

6. The laser module as claimed in claim 1, wherein said circuit board is mounted inside said housing.
